(19) United States
(12) Patent Application Publication
(10) Pub. No.: US 2005/0035165 A1
(43) Pub. Date: Feb. 17, 2005

(54) LOCK MOUNT OF A BICYCLE

(76) Inventor: Cheng-Che Tsai, Yung Kang City (TW)

Correspondence Address: Alan D. Kamrath;Rider Bennett, LLP, Suite 2000, 333 South Seventh Street, Minneapolis, MN, 55402, US

(21) Appl. No.: 10/641,375

(22) Filed: Aug. 14, 2003

(51) Int. Cl. B62J 7/00; B62J 9/00; B62J 11/00

(52) U.S. Cl. 224/427; 224/448

(57) ABSTRACT

A lock mount of a bicycle is disclosed. The lock mount comprises a base secured to a seat tube of the bicycle and an opening; an abutment assembly comprising legs exposed to an underside of the base, two diametrically opposite recesses on a wall, and a hole; a cylindrical assembly comprising two diametrically opposite pins on the recesses, a bottom post, and a spring receptacle; a cover comprising an annular flange; and a tubular member slid through channels between legs with the post inserted through the hole into an aperture of the tubular member for locking. Whereby rotating the tubular member will cause the pins to climb toward sides of the recesses with the spring means being compressed and the post being lifted away from the aperture until the tubular member is unlocked.

### BACKGROUND OF THE INVENTION

1. Field of the Invention

The present invention relates to bicycle locks and more particularly to a lock mount of a bicycle with improved characteristics.

2. Description of Related Art

Conventionally, many different techniques are used to securely place a lock on a bicycle in an unlocked state. Unfortunately, such prior techniques suffered from one or more of following drawbacks such as unreliability, unsightliness, and complication. Thus, the need for improvement still exists.

### SUMMARY OF THE INVENTION

It is an object of the present invention to provide a lock mount of a bicycle, comprising a base comprising a C-shaped cylinder at one side, the cylinder including a plurality of parallel, longitudinal ridges on an inner surface, a pair of holed lugs at a mouth, and a plurality of longitudinal grooves on an outer surface diametrically opposite the lugs, a first opening at the other side, and an annular shoulder around the first opening wherein a seat tube of the bicycle is fastened in the cylinder by driving a fastener through the holed lug; a cylindrical abutment assembly comprising a plurality of equally spaced apart legs, an annular wall, two diametrically opposite, arcuate recesses on the wall, and a central hole wherein the abutment assembly is put on the shoulder with the legs exposed to an underside of the base; a cylindrical assembly comprising two diametrically opposite pins, a post extended from an underside, a central receptacle, and resilient means; a cover comprising an annular flange extended from an underside, two diametrically opposite slots on the flange, and a plurality of tabs proximate one side of the flange; and a tubular member for permitting a shank of the lock to releasably pass through, the tubular member comprising an upper fastening element and an aperture on the fastening element, wherein the fastening element is slid through one channel between two adjacent legs and the other opposite channel between another two adjacent legs until the central hole is aligned with the aperture, the cylindrical assembly is placed in the abutment assembly with the pins seated on the recesses and received in the slots, and the post inserted through the central hole into the aperture for locking the tubular member, the cover is put on a mated portion of the base with the resilient means compressed in a space confined by the flange and the receptacle and the tabs inserted into the grooves, and the base and the cover are threadedly fastened together, whereby rotating the tubular member for causing the pins to climb toward sides of the recesses with the resilient means being compressed and the post being lifted away from the aperture until the tubular member is unlocked will enable the tubular member and the lock to be detached from the lock mount.

The above and other objects, features and advantages of the present invention will become apparent from the following detailed description taken with the accompanying drawings.

### BRIEF DESCRIPTION OF THE DRAWINGS

FIG. 1 is an exploded view of a preferred embodiment of lock mount of bicycle according to the invention;

FIG. 2 is an assembled view of FIG. 1, where a lock is shown in dash lines;

FIG. 3 schematically depicts steps of locking of the tubular member in the lock mount;

FIG. 4 schematically depicts steps of unlocking the tubular member; and

FIG. 5 is a side view showing the lock mount installed in a bicycle.

### DETAILED DESCRIPTION OF THE PREFERRED EMBODIMENTS

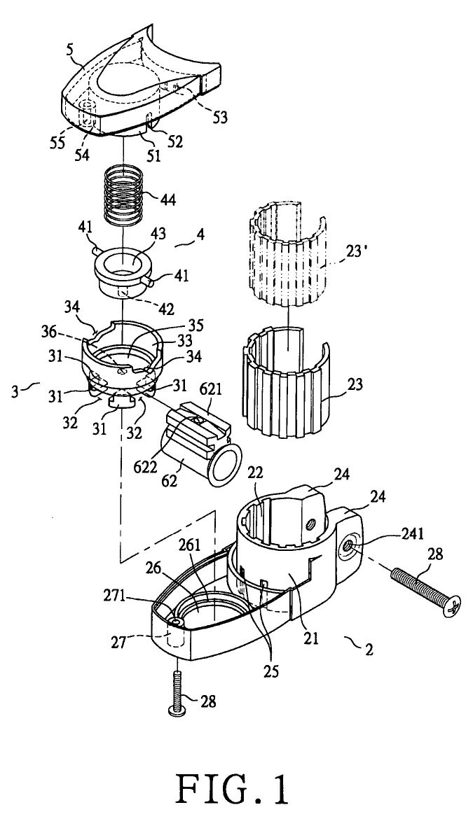

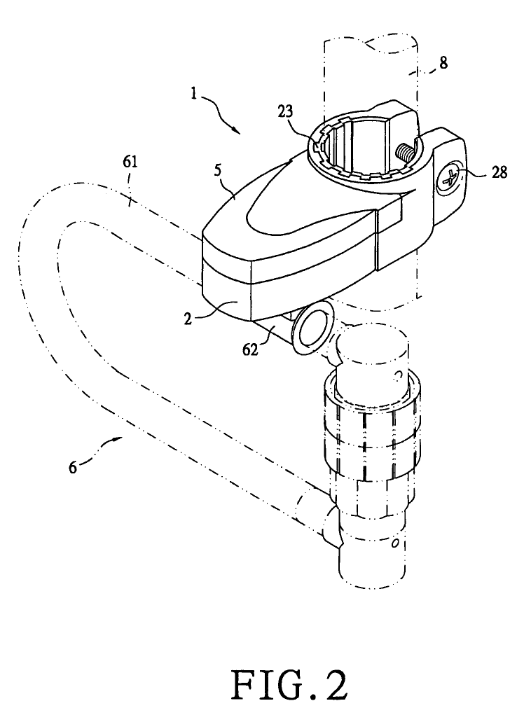

Referring to FIGS. 1 and 2, there is shown a lock mount 1 for a lock 6 of bicycle constructed in accordance with the invention. The lock mount 1 comprises a base 2 comprising a C-shaped cylinder 21 at one side, the cylinder 21 having a plurality of parallel, longitudinal ridges 22 on an inner surface, a pair of lugs 24 at a mouth, each lug 24 having a lateral hole 241, and a plurality of (two) longitudinal grooves 25 on an outer surface diametrically opposite the lugs 24, a C-shaped sleeve 23 (or 23′) put on a seat tube 8 prior to snapping into the cylinder 21, an opening 26 at the other side, an annular shoulder 261 around the opening 26, and a peg 27 proximate the opening 26, the peg 27 having a hole 271 therethrough; a cylindrical abutment assembly 3 comprising a plurality of legs 21 around an underside, a plurality of channels 32 each between two adjacent legs 21, an annular wall 33, two diametrically opposite, arcuate recesses 34 on the wall 33, a central hole 36, and an annular bottom 35 around the hole 36; a cylindrical assembly 4 comprising two diametrically opposite pins 41, a post 42 extended from a center of underside, a central receptacle 43, and a spring 44 received in the receptacle 43; a cover 5 comprising an annular flange 51 extended from an underside, two diametrically opposite slots 52 on the wall of the flange 51, a plurality of (two) tabs 53 proximate one side of the flange 51, and a peg 54 having a hole 55 therethrough proximate the other side of the flange 51; and a tubular member 62 including an upper fastening element 621 and an aperture 622 on a center of the fastening element 621.

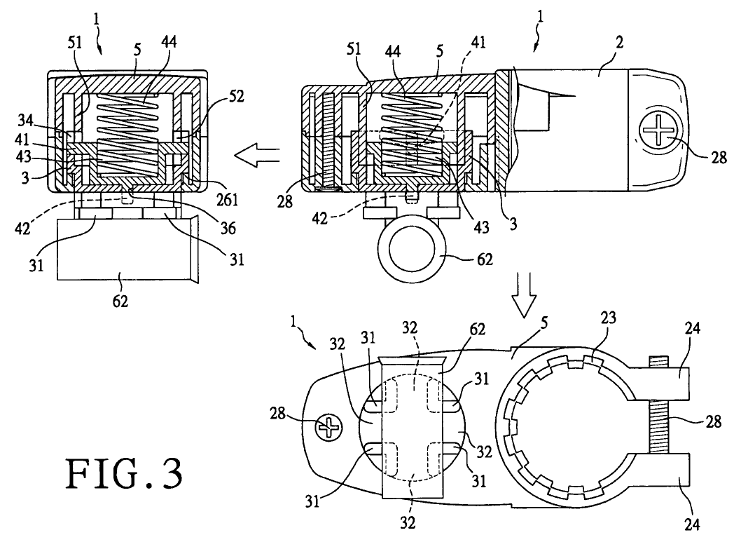

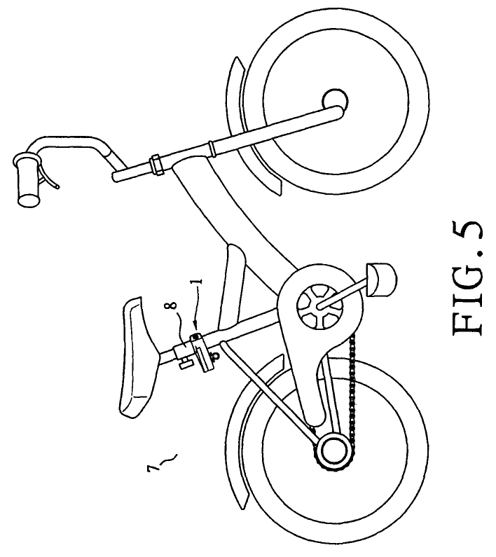

Referring to FIGS. 3 and 5 in conjunction with FIG. 2, an assembly of the invention will now be described in detail below. Drive a bolt 28 through the holes 241 for fastening the seat tube 8 and the cylinder 21 together. Put the abutment assembly 3 on the shoulder 261 with the legs 31 exposed to the underside of the base 2. Slide the fastening element 621 through two opposite channels 32 until the hole 36 is aligned with the aperture 622. Place the cylindrical assembly 4 in the abutment assembly 3 with the pins 41 seated on the recesses 34 and received in the slots 52, and the post 42 inserted through the hole 26 into the aperture 622 for locking the tubular member 62. Put the cover 5 on a mated portion of the base 2 with the spring 44 compressed in a space confined by the flange 51 and the receptacle 43 and the tabs 53 snugly inserted into the grooves 25. Drive a screw 28 through the hole 271 into the hole 55 for fastening the base 2 and the cover 5 together. At this time, a driver can insert a shank 61 of the lock 6 through the tubular member 62 prior to locking the lock 6 on the seat tube 8. At this position, the lock 6 is securely placed on a bicycle 7.

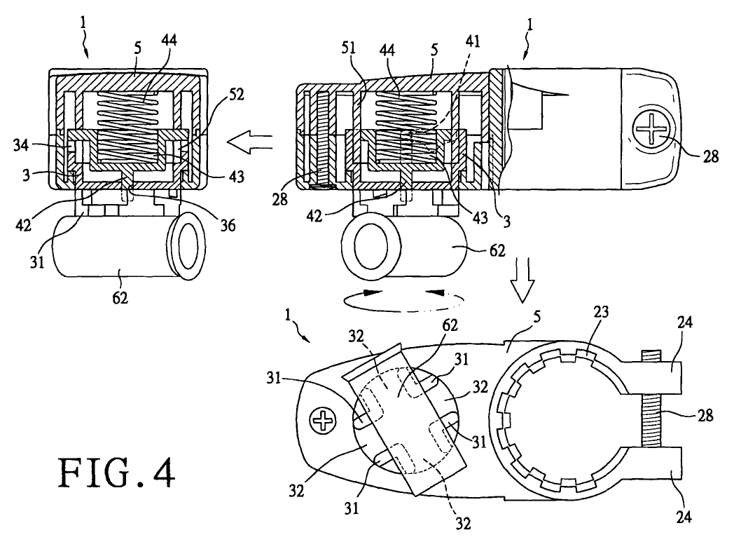

An operation of detaching the lock 6 from the lock mount 1 will now be described in detail below by referring to FIG. 4 in conjunction with FIG. 5. Use the hand to rotate the tubular member 62 for causing the pins 41 to climb toward sides of the recesses 34 with the spring 44 being compressed and thus lifting the post 42 away from the aperture 622 until the tubular member 62 is unlocked. At this moment, a driver can detach the lock 6 including the tubular member 62 from the lock mount 1 prior to using the lock 6 to lock the wheel of the bicycle 7.

While the invention herein disclosed has been described by means of specific embodiments, numerous modifications and variations could be made thereto by those skilled in the art without departing from the scope and spirit of the invention set forth in the claims.

1. A mount for a lock of a bicycle, comprising:
a base comprising a C-shaped cylinder at one side, the cylinder including a plurality of parallel, longitudinal ridges on an inner surface, a pair of holed lugs at a mouth, and a plurality of longitudinal grooves on an outer surface diametrically opposite the lugs, a first opening at the other side, and an annular shoulder around the first opening wherein a seat tube of the bicycle is fastened in the cylinder by driving a fastener through the holed lug;
a cylindrical abutment assembly comprising a plurality of equally spaced apart legs, an annular wall, two diametrically opposite, arcuate recesses on the wall, and a central hole wherein the abutment assembly is put on the shoulder with the legs exposed to an underside of the base;
a cylindrical assembly comprising two diametrically opposite pins, a post extended from an underside, a central receptacle, and resilient means;
a cover comprising an annular flange extended from an underside, two diametrically opposite slots on the flange, and a plurality of tabs proximate one side of the flange; and
a tubular member for permitting a shank of the lock to releasably pass through, the tubular member comprising an upper fastening element and an aperture on the fastening element,
wherein the fastening element is slid through one channel between two adjacent legs and the other opposite channel between another two adjacent legs until the central hole is aligned with the aperture, the cylindrical assembly is placed in the abutment assembly with the pins seated on the recesses and received in the slots, and the post inserted through the central hole into the aperture for locking the tubular member, the cover is put on a mated portion of the base with the resilient means compressed in a space confined by the flange and the receptacle and the tabs inserted into the grooves, and the base and the cover are threadedly fastened together, whereby rotating the tubular member for causing the pins to climb toward sides of the recesses with the resilient means being compressed and the post being lifted away from the aperture until the tubular member is unlocked will enable the tubular member and the lock to be detached from the mount.

2. The mount of claim 1, wherein the cylinder further comprises a C-shaped sleeve put on the seat tube prior to snapping into the cylinder.
